(19) United States
(12) Patent Application Publication
(10) Pub. No.: US 2017/0085461 A1
(43) Pub. Date: Mar. 23, 2017

(54) COLOR ASSIGNMENTS FOR PEER-TO-PEER (P2P) TRANSMISSIONS

(71) Applicant: QUALCOMM Incorporated, San Diego, CA (US)

(72) Inventors: Yan ZHOU, San Diego, CA (US); Gwendolyn Denise BARRIAC, Encinitas, CA (US); Simone MERLIN, San Diego, CA (US); George CHERIAN, San Diego, CA (US); Alfred ASTERJADHI, San Diego, CA (US); Qingjiang TIAN, San Diego, CA (US); Gang DING, San Diego, CA (US)

(21) Appl. No.: 15/266,290

(22) Filed: Sep. 15, 2016

Related U.S. Application Data
(60) Provisional application No. 62/222,759, filed on Sep. 23, 2015.

(51) Int. Cl. H04L 12/751; H04L 5/00

(52) U.S. Cl. CPC H04L 45/02; H04L 5/0007; H04L 67/104

(57) ABSTRACT

Systems and methods for wireless communications are disclosed. More particularly, aspects generally relate to techniques for wireless communications by an apparatus comprising determining a first identifier for use in identifying an intended recipient of frames transmitted by members of a peer-to-peer group, generating a first frame having a signal field including the first identifier, and outputting the first frame for transmission to at least one of the members in the peer-to-peer group. Other aspects generally relate to techniques for wireless communications by an apparatus comprising assigning a first identifier to a first peer-to-peer group for use in identifying intended recipients of frames transmitted by members of the first peer-to-peer group, generating a first frame having an indication of the first identifier, and outputting the first frame for transmission to at least one of the members of the first peer-to-peer group.

### CLAIM OF PRIORITY UNDER 35 U.S.C. §119

The present application for patent claims benefit of U.S. Provisional Patent Application Ser. No. 62/222,759, filed Sep. 23, 2015 and assigned to the assignee hereof and hereby expressly incorporated by reference herein.

### BACKGROUND

Field of the Disclosure

Certain aspects of the present disclosure generally relate to assignments of color values for wireless peer-to-peer (P2P) transmissions.

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

Improvements to wireless P2P communications by wireless stations may be had by utilizing values assigned to a color field by the wireless stations for use in P2P communications. Color bits enable a receiving station to make a quick determination on the relevance of a received frame and either process the frame or ignore the frame. This quick determination may allow the receiving station to also transmit or receive (e.g., reuse) another signal on top of received signal upon determining that the received signal is not relevant to the receiving station.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Each of various implementations of systems, methods, and devices within the scope of the appended claims has one or more aspects and no single aspect is solely responsible for desirable attributes described herein. Without limiting the scope of the appended claims, certain features are described herein. In view of this discussion, and, particularly of the “Detailed Description,” one will understand how features of various aspects allow generating and transmitting, by a device, such as an access point, a frame that indicates both minimum and maximum bandwidths for communication in a network. Furthermore, one will understand how various aspects allow determining, by a device, such as a user equipment, both minimum and maximum bandwidths for communicating in the network based on a frame received from the access point.

Aspects of the present disclosure provide an apparatus for wireless communications. The apparatus generally includes a processing system configured to determine a first identifier for use in identifying an intended recipient of frames transmitted by members of a peer-to-peer group, and to generate a first frame having a signal field including the first identifier. The apparatus generally also includes a first interface configured to output the first frame for transmission to at least one of the members in the peer-to-peer group.

Aspects of the present disclosure provide an apparatus for wireless communications. The apparatus generally includes a processing system configured to assign a first identifier to a first peer-to-peer group for use in identifying intended recipients of frames transmitted by members of the first peer-to-peer group, and to generate a first frame having an indication of the first identifier. The apparatus generally also includes a first interface configured to output the first frame for transmission to at least one of the members of the first peer-to-peer group.

Aspects of the present disclosure provide a method for wireless communications. The method generally includes determining a first identifier for use in identifying an intended recipient of frames transmitted by members of a peer-to-peer group, generating a first frame having a signal field including the first identifier, and outputting the first frame for transmission to at least one of the members in the peer-to-peer group.

Aspects of the present disclosure provide a method for wireless communications. The method generally includes assigning a first identifier to a first peer-to-peer group for use in identifying intended recipients of frames transmitted by members of the first peer-to-peer group, generating a first frame having an indication of the first identifier, and outputting the first frame for transmission to at least one of the members of the first peer-to-peer group.

Aspects of the present disclosure provide an apparatus for wireless communications. The apparatus generally includes means for determining a first identifier for use in identifying an intended recipient of frames transmitted by members of a peer-to-peer group, means for generating a first frame having a signal field including the first identifier, and means for outputting the first frame for transmission to at least one of the members in the peer-to-peer group.

Aspects of the present disclosure provide an apparatus for wireless communications. The apparatus generally includes means for assigning a first identifier to a first peer-to-peer group for use in identifying intended recipients of frames transmitted by members of the first peer-to-peer group, means for generating a first frame having an indication of the first identifier, and means for outputting the first frame for transmission to at least one of the members of the first peer-to-peer group.

Aspects of the present disclosure provide a computer readable medium for wireless communications having instructions stored thereon. The instructions are generally are for determining a first identifier for use in identifying an intended recipient of frames transmitted by members of a peer-to-peer group, generating a first frame having a signal field including the first identifier, and outputting the first frame for transmission to at least one of the members in the peer-to-peer group.

Aspects of the present disclosure provide a computer readable medium for wireless communications having instructions stored thereon. The instructions are generally for assigning a first identifier to a first peer-to-peer group for use in identifying intended recipients of frames transmitted by members of the first peer-to-peer group, generating a first frame having an indication of the first identifier, and outputting the first frame for transmission to at least one of the members of the first peer-to-peer group.

Aspects of the present disclosure provide a wireless node. The wireless node generally includes and antenna, a processing system configured to determine a first identifier for use in identifying an intended recipient of frames transmitted by members of a peer-to-peer group, and to generate a first frame having a signal field including the first identifier, and a first interface configured to output, via the antenna, the first frame for transmission to at least one of the members in the peer-to-peer group.

Aspects of the present disclosure provide an access point. The access point generally includes an antenna, a processing system configured to assign a first identifier to a first peer-to-peer group for use in identifying intended recipients of frames transmitted by members of the first peer-to-peer group, and to generate a first frame having an indication of the first identifier, and a first interface configured to output, via the antenna, the first frame for transmission to at least one of the members of the first peer-to-peer group.

Certain aspects also provide various methods, apparatuses, and computer program products capable of performing operations corresponding to those described above.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example S1G PPDU frame format, in accordance with certain aspects of the present disclosure.

FIG. 5 illustrates a block diagram of example operations for wireless communications by an apparatus, in accordance with certain aspects of the present disclosure.

FIG. 5A illustrates example means capable of performing the operations shown in FIG. 5.

FIG. 6 illustrates a block diagram of example operations for wireless communications by an apparatus, in accordance with certain aspects of the present disclosure.

FIG. 6A illustrates example means capable of performing the operations shown in FIG. 6.

FIGS. 7A-7D illustrates diagrams of P2P color assignments, in accordance with certain aspects of the present disclosure.

FIGS. 8A and 8B illustrate diagrams of P2P color assignments, in accordance with certain aspects of the present disclosure.

### DETAILED DESCRIPTION

Aspects of the present disclosure provide techniques that may improve system performance by introducing color bits for peer-to-peer (P2P) transmissions between nodes. Color bits refer to bits included in a preamble of a packet (e.g., in a signal or SIG field) that may enable a receiving station to quickly detect whether the frame being received is associated with a P2P group with which the receiving station is associated with. Where the receiving station determines that the frame does not have the same color as the receiving station, the receiving station may cease the reception process. For example, the receiving station may ignore the remainder of the frame and go to sleep, or alternatively reuse wireless resources.

As used herein, the term fading generally refers to the deviation of attenuation affecting a wireless signal over the propagation media. The fading may vary with time, geographical position or frequency. Fading may be due to different factors, such as multipath propagation (in which a receiver sees the superposition of multiple copies of the transmitted signal, each traversing a different path) or due to shadowing from obstacles affecting the wave propagation.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may use sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system uses orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may use interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium.

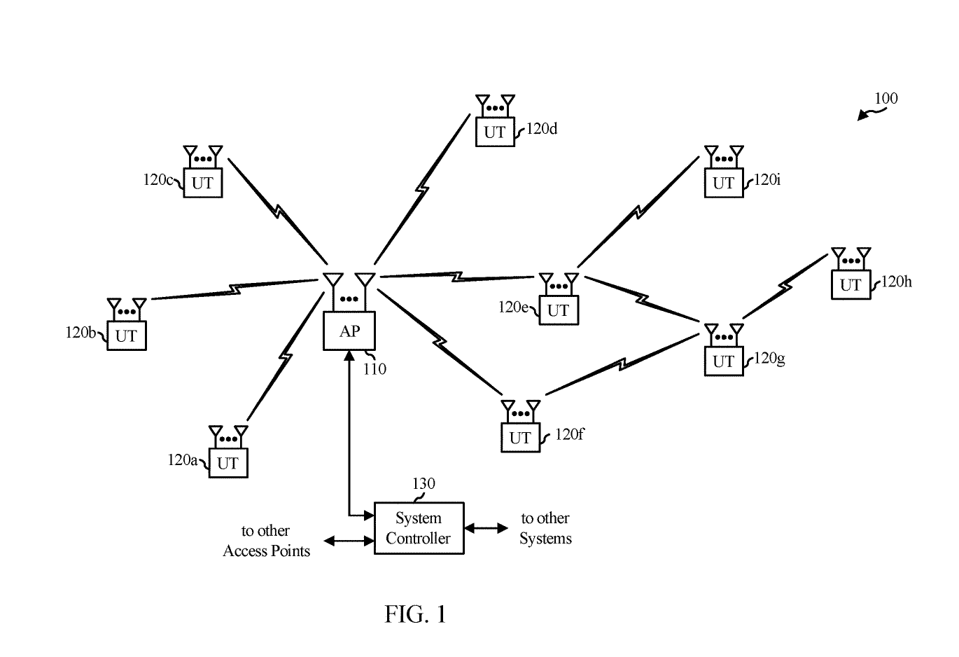

FIG. 1 illustrates a system 100 in which aspects of the disclosure may be performed. For example, the access point 110 or user terminal 120 may determine whether another access point 110 or user terminal 120 is capable of receiving a paging frame (e.g., an ultra low-power paging frame) via a second radio (e.g., a companion radio), while a first radio (e.g., a primary radio) is in a low-power state. The access point 110 or user terminal 120 may generate and transmit the paging frame comprising a command field (e.g., a message ID field) that indicates one or more actions for the other access point 110 or user terminal 120 to take.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer (P2P) with another user terminal. In the example shown in FIG. 1, UEs 120e and 120i may communicate directly with each other without communicating with an eNB in wireless network 100. P2P communication may reduce the load on wireless network 100 for local communications between UEs. P2P communication between UEs may also allow one UE to act as a relay for another UE, thereby enabling the other UE to connect to an eNB. A system controller 130 may couple to and provide coordination and control for the access point.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also use a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

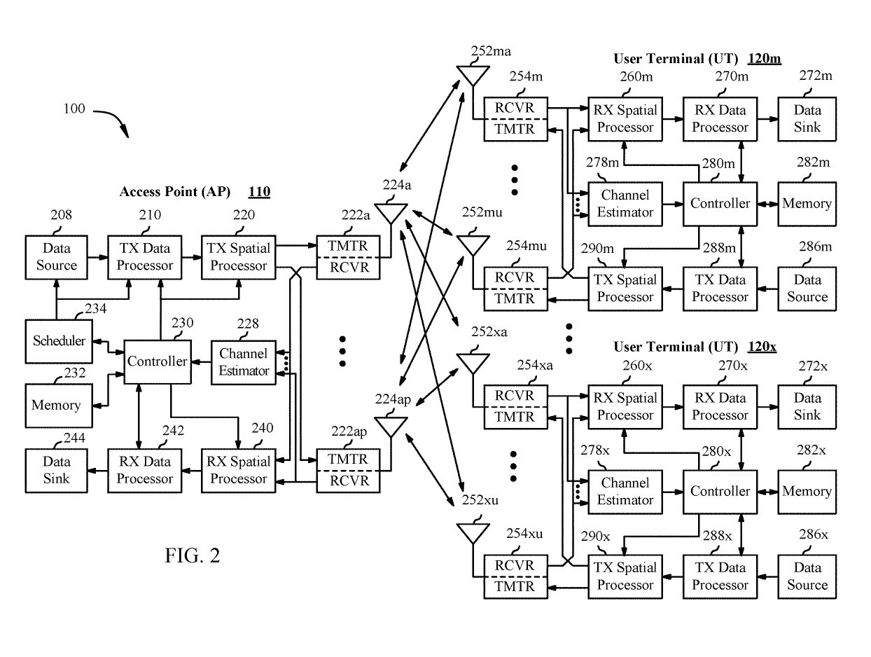

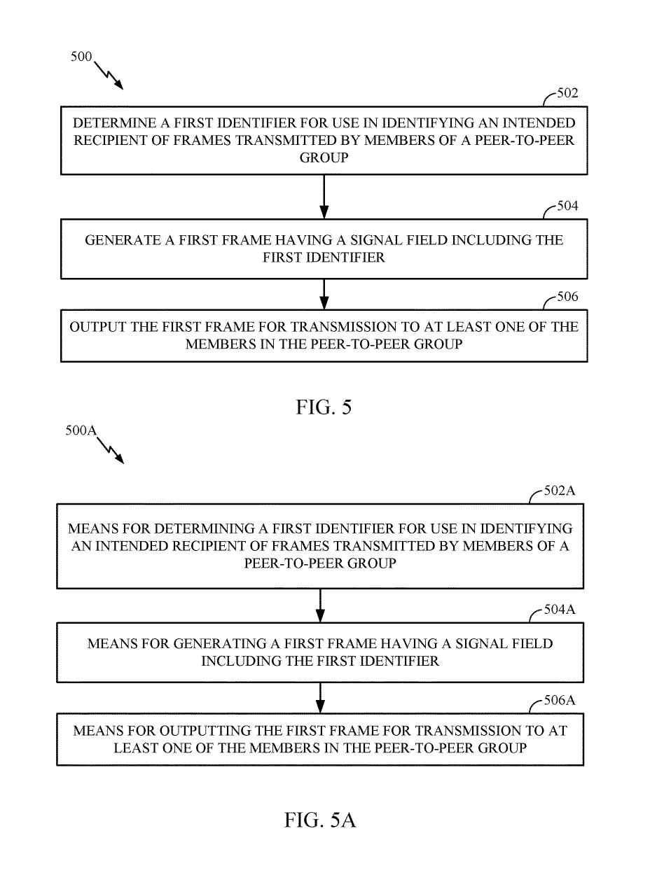

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 may be used to perform the operations described herein and illustrated with reference to FIGS. 17-18A. Similarly, antenna 252, Tx/Rx 254, processors 260, 270, 288, and 290, and/or controller 280 of the UT 120 may be used to perform the operations described herein and illustrated with reference to FIGS. 5-5A.

FIG. 2 illustrates a block diagram of access point 110 and two user terminals 120m and 120x in MIMO system 100. The access point 110 is equipped with N antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals are simultaneously transmit on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 208 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix Hdn,m for that user terminal. Controller 230 derives the spatial filter matrix for the access point based on the effective uplink channel response matrix Hup,eff. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

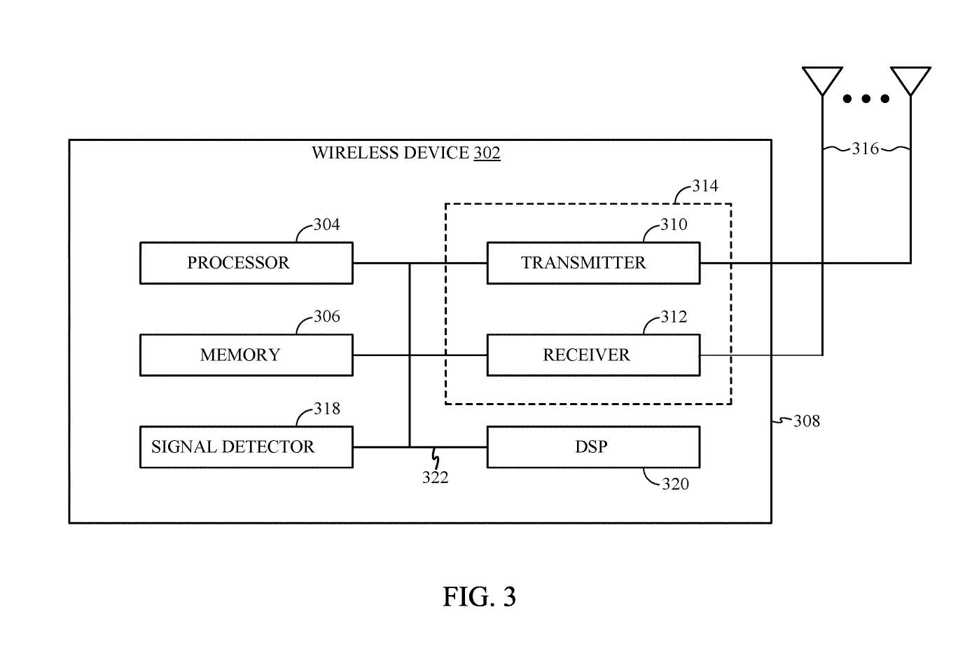

FIG. 3 illustrates example components that may be utilized in the AP 110 and/or UT 120 to implement aspects of the present disclosure. For example, the transmitter 310, antenna(s) 316, processor 304 and/or the DSP 320 may be used to practice aspects of the present disclosure implemented by the AP. Further, the receiver 312, antenna(s) 316, processor 304 and/or the DSP 320 may be used to practice aspects of the present disclosure implemented by the UT.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Certain aspects of the present disclosure support a method for establishing a direct link between a pair of apparatuses (e.g., stations or user terminals 120), The direct link may correspond to a communication link directly established between a station and a peer station in a wireless network (e.g., in the network 100 from FIG. 1). Moreover, the wireless network may comprise at least one access point (e.g., the access point 110) that may serve as an intermediary for transmissions between the station and the peer station. Once the direct link is set, these peer stations may directly communicate via the direct link without using any additional intermediary communication entity (e.g., the access point). According to certain aspects of the present disclosure, the direct link may comprise an independent BSS (IBSS), mesh BSS (MBSS), neighborhood awareness network (NAN), WiFi-Direct, Tunneled Direct Link Setup (TDLS), or other P2P protocol or channel between the station and the peer station.

### Color Assignments for P2P

As noted above, aspects of the present disclosure provide techniques that may improve system performance by introducing color bits for peer-to-peer (P2P) transmissions between nodes.

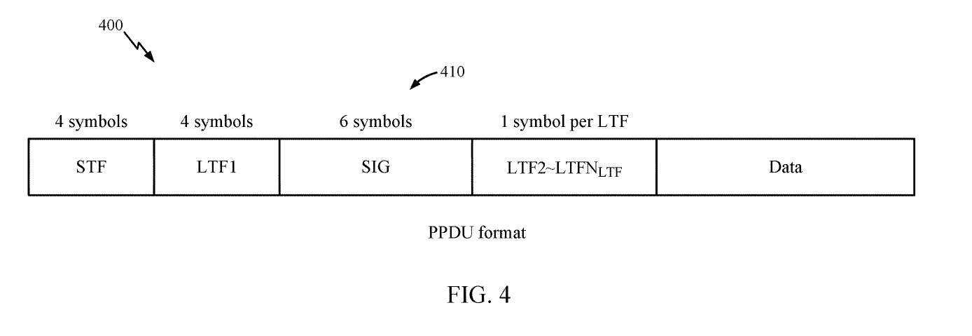

In accordance with certain aspects of the present disclosure, a receiver of a frame may be able to determine the P2P group of the intended receiver of the frame based on information contained in the physical layer convergence protocol (PLCP) protocol data unit (PPDU). FIG. 4 illustrates an example PPDU frame format 400, in accordance with certain aspects of the present disclosure. A PPDU may contain one or more signal (SIG) fields 410 in the physical layer (PHY) header. For example, a high efficiency (HE) single user (SU) PPDU may contain a color field in a SIG-A field.

The color field may be used to assist a receiving station identify a BSS from which a received transmission originates. The color enables the receiving station to detect that the frame being received is not from the BSS with which the station is associated with and cease the reception process. For example, the receiving station may ignore the remainder of the frame and go to sleep, or alternatively reuse wireless resources. As used herein, reuse of wireless resources such as time slots and channels, refers to transmitting or receiving a signal on top of another signal.

The value of the color field may be chosen by the AP for a BSS. The color field may be 3-6 bits and allow for 8-64 possible color values (e.g., identifiers). In networks with centralized management and control, for example through a centralized controller, color values may be allocated to the AP's such that it is possible to guarantee that each BSS has a color value different from the color value of an overlapping BSS (OBSS). While color bits have been defined for communications in the context of an AP, it is not clear what role color bits may play for P2P communications.

FIG. 5 illustrates example operations 500 for a wireless communications by an apparatus, in accordance with aspects of the present disclosure. The operations 500 may be performed by an apparatus, such as a station.

Operations 500 may begin at 502, by determining a first identifier for use in identifying an intended recipient of frames transmitted by members of a peer-to-peer group. At 504, generate a first frame having a signal field including the first identifier. At 506, output the first frame for transmission to at least one of the members in the peer-to-peer group.

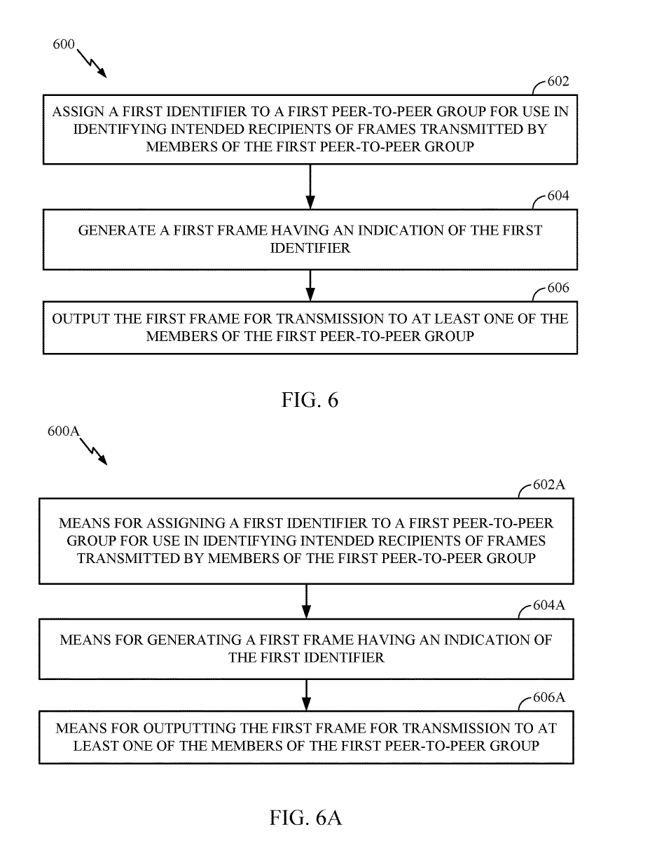

FIG. 6 illustrates a block diagram of example operations 600 for wireless communications by an apparatus, in accordance with certain aspects of the present disclosure. The operations 600 may be performed by an apparatus, such as an access point.

Operations 600 may begin at 602, by assigning a first identifier to a first peer-to-peer group for use in identifying intended recipients of frames transmitted by members of the first peer-to-peer group. At 604, generate a first frame having an indication of the first identifier. At 606, output the first frame for transmission to at least one of the members of the first peer-to-peer group.

In order to improve P2P communications, values may be assigned for a color field for use in P2P communications. According to certain aspects, an AP may assign a color value to one or more stations for use in P2P communications. Where the AP assigns the color value, the AP may also configure rules (e.g. parameters) for color based P2P reuse, in certain cases. According to other aspects, P2P stations may automatously assign a color value for P2P communications.

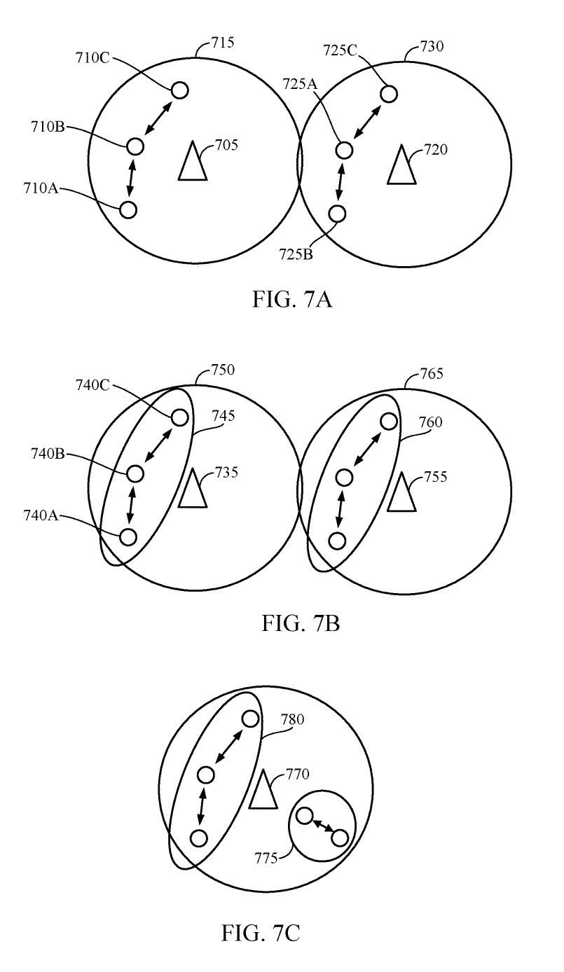

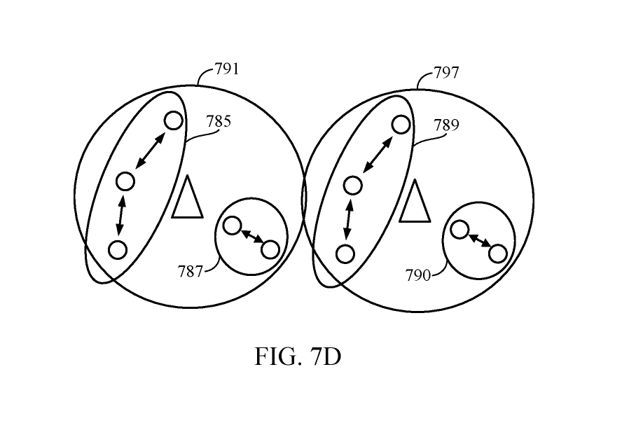

FIG. 7A illustrates a diagram of P2P color assignments, in accordance with certain aspects of the present disclosure. Where an AP assigns a color value for P2P communications, the AP 705 may assign all stations associated with the AP 710A-710C in a peer-to-peer group a color value matching the color value of the AP's BSS color value 715. Likewise AP 720 may assign stations 125A-725C in a P2P group associated with the station a color value that is the same color as the AP's BSS color value 730. For example, P2P group 710A-710C may be assigned the same color value 715 as AP 705 and P2P group 720A-720C assigned the same color value 730 as AP 720. Where all P2P stations have the same color value, each station with the same color value may defer (e.g., delay) to transmissions from the interfering BSS, as well as other P2P transmissions with the same color with no reuse. This deferral may be at least one of a time slot or a frequency channel and at least one member of the P2P group may coordinate the deferral by making deferral decisions for interfering frames. This at least one member may generate a frame indicating the time slot or frequency channel for deferral and output the frame to other members of the P2P group.

FIG. 7B illustrates a diagram of P2P color assignments, in accordance with certain aspects of the present disclosure. As shown, an AP 735 may select all P2P stations 740A-740C associated with the AP 735 and group all the P2P stations 740A-740C in a single reusing P2P group (RPG) 745 with a single value for a color field 745 different from the AP 735 BSS color 750. Likewise AP 755 may group associated P2P station into a single P2P RPG 760 having a color value different from the AP 755 BSS color value 765. This color difference enables an RPG to reuse over transmissions by non-members of the RPG, such as those associated with BSSs such as those associated with BSS color value 750 and BSS color value 765.

RPG color may also vary across different BSSs. For example, the color value assigned for an RPG may be different from the RPG color value used by another BSS, the BSS color used by the AP (InBSS), and the BSS color used by an overlapping BSS (OBSS), which may be a neighboring BSS operating in the same frequency and radio range of the AP's BSS. Where the RPG color of a received packet does not match and is different from a color value used by a RPG, the RPG may reuse over the received packet of another RPG. For example, where a first RPG associated with a first BSS has a different color than a second RPG associated with a second BSS, the first RPG may reuse over the second RPG and vice versa. Additionally or alternatively, RPG color may be constant across different BSSs to reserve at least one color for use for P2P. Where a single color is reserved, an RPG may reuse over BSS transmissions but not over other RPG transmissions. The common RPG color may be determined by a central controller in a managed network or by standards.

In order to facilitate RPG color selection, an AP may broadcast the BSS and RPG colors used. Other APs may then receive this broadcast, obtain information about RPG colors used by the AP, and perform RPG color selection based on the BSS and RPG colors already in use by the AP.

According to certain aspects of the present disclosure, an AP may configure P2P reuse parameters (e.g., criteria) for color based P2P reuse by wireless devices configured for P2P operations. These P2P reuse parameters may include criteria associated with signal quality, such a received signal strength indicator (RSSI) threshold. A wireless device operating in an RPG may drop a frame from other RPGs and BSSs when an RSSI of the frame falls below the RSSI threshold. In some embodiments, an AP may configure a single RSSI threshold for an RPG to utilize to drop frames, applicable for any frame with a color value different from the assigned color value of the receiving station.

In other embodiments, an AP may configure two different RSSI thresholds for an RPG to utilize to drop frames. For example, the AP may configure one RSSI threshold for RPGs with a different color value and another RSSI threshold for BSSs with a different color value. A higher threshold may be set for RPGs as compared to BSSs in order to prioritize BSS traffic. In another embodiment, an AP may configure an RPG with four different RSSI thresholds to use for dropping InBSS RPGs, OBSS RPGs, InBSS, and OBSSs, respectively, each having a different color value. A station may be able to distinguish whether a received frame is associated with an RPG or BSS based on, for example, a broadcast by an AP indicting which colors are used and which colors are associated with RPGs and which colors are associated with BSSs or an indicator in the PHY header of an infrastructure or RPG color along with the color value.

Additionally or alternatively, an AP may configure RSSI thresholds at BSS nodes drop frames from other RPGs or BSSs. In one embodiment, an AP may configure two different RSSI thresholds for a BSS node to utilize to drop frames from RPGs and OBSSs, respectively, with a different color. In another embodiment, an AP may configure a BSS node with three different RSSI threshold to use for dropping InBSS RPGs, OBSS RPGs, and OBSSs, respectively, having a different color value. The AP may convey the various thresholds via one or more frames sent by the AP to the wireless devices.

Other P2P reuse parameters that may be configured for color based P2P reuse may include a max allowed interference level in RPG frames for other RPGs and BSSs to utilize in making a drop decision. For example, an AP, for a particular RPG, may configure a max allowed interference level indicated in RPG frames, which are received by the other RPG or BSS, from the particular RPG. Where the interference caused by other RPG or BSS to the frame receiver and/or transmitter, is less than the max allowed interference level, the other RPG or BSS may drop the received frame from the particular RPG. Further, an AP may instruct a particular station to indicate the particular station's transmission power in an RPG frame to facilitate estimating the caused interference by other RPGs or BSSs. Additionally, multiple max interference levels may be configured, for example for other RPGs and BSSs to make drop decisions. In an embodiment, two levels can be configured for other RPGs and BSSs, respectively. In another embodiment, three levels can be configured for other RPGs, InBSS, and OBSSs, respectively.

An AP may also configure other P2P reuse parameters. For example, an AP may schedule P2P reuse resources, such as time slots and/or channels, allowed RPG colors, RPG IDs, and BSS station IDs per reusing resource. The AP may also configure stations for P2P reuse by configuring station settings for use when engaged in P2P communications, such as setting a max allowed transmit power and antenna number for P2P reuse, as well as enable or disable using a request-to-send/clear-to-send exchange to carry an indication of RPG color values, max allowed interference, or max allowed transmit power to allow other stations to able to better determine whether to reuse resources. Generally, RPG color values should be different from InBSS and OBSS color values, as well as color values of other RPGs in the OBSS to allow for reuse over each other. Where multiple reusing time slots are available, color values should be different per time slot. For example, multiple RPGs may be assigned the same color value where the multiple RPGs using the same color value utilize different time slots.

P2P reuse parameters may be common for all RPGs, or set on a per RPG or BSS basis. Configurations may be broadcast to all RPGs or unicast to each RPG member. Further, stations may transmit a RPG reusing performance report indicating, for example, a throughout rate, latency, packet error rate, number of retires, etc., in RPG reuse. These RPG reusing performance reports may be used by the AP to update configurations.

An AP may configure scheduling for P2P transmissions by P2P groups. For example, an AP may schedule P2P time slots or channels to avoid infrastructure transmissions addressed to stations in a P2P group or transmissions from P2P stations to infrastructure. An AP may indicate to a particular station to perform infrastructure communications during a particular time window, allowing other stations to preform P2P communications during that window. Alternatively or in addition, an AP may indicate a time window to stations not scheduled for infrastructure transmissions so these stations may perform P2P communications during the time window.

FIG. 7C illustrates a diagram of P2P color assignments, in accordance with certain aspects of the present disclosure. According to certain aspects, an AP 770 may select different colors for multiple P2P groups 775 and 780. As a part of this selecting, the AP 770 may identify multiple RPGs. For the RPGs to reuse over each other, the AP 770 should select isolated RPGs such that there is no cross communications between member stations of each RPG, as shown in 775 and 780. This avoid issues where a station in a first RPG attempting to communicate to a station in a second RPG during an ongoing frame in the second RPG. The AP may also schedule P2P reusing resources such that isolated RPGs do not use overlapping (e.g., non-overlapping) time windows to reduce possible cross communications.

According to certain aspects, each station may report the neighbor stations that the station is associated with or have traffic sessions set up with using P2P protocols to help an AP identify isolated RPGs. This reporting may be updated by the station during a setup or teardown of an association or traffic session with the neighbor station. Alternatively or in addition, the AP may poll for this reporting or sniff traffic from the stations to identify which stations are in P2P communications with which neighbor stations.

The AP may also broadcast and receive information from other APs indicating the colors in use or available for use. For example, an AP may broadcast its BSS and RPG colors used in its BSS(s) so other BSSs can determine RPG colors already in use and select different BSS and RPG colors. As another example, multiple reusing time slots may be synchronized across multiple BSSs. Where time slots are synchronized across BSSs, an AP may broadcast information about the AP's BSS and RPG colors used per time slot so other BSSs may select different colors per time slot. Additionally or alternatively, a station may report the information to the AP regarding BSS and RPG colors used by an OBSS in case the AP cannot receive broadcasts from the OBSS AP.

Once RPGs are identified, an AP may assign different color values to different RPGs. These RPG colors may be different from color values associated with OBSS and InBSS, as well as RPG colors used in OBSSs to allow reuse. For example, the color value of RPG 785 in FIG. 7D may be different from the color value of RPGs 787, 789, and 790, as well as BSS 791 and BSS 797. An AP may also assign P2P reuse parameters, as described above, after or concurrently with RPG identification.

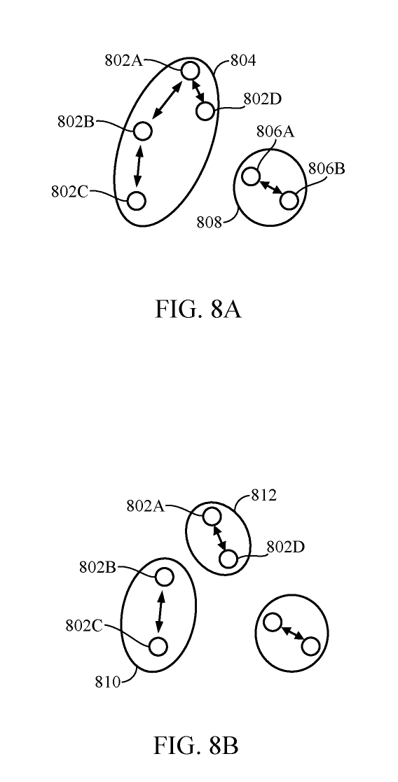

FIGS. 8A and 8B illustrates a diagram of P2P color assignments, in accordance with certain aspects of the present disclosure. According to certain aspects of the present disclosure, stations may autonomously select colors for color-based P2P reuse. For example, P2P nodes not associated with an AP 802A-802C and 806A-806B may autonomously select a color value. In some cases, a peer-to-peer group, as shown here as 802A-802C and 806A-806B, may be formed using a P2P networking technology with a unique network identifier. For example an independent BSS (IBSS), mesh BSS (MBSS), neighborhood awareness network (NAN), WiFi-Direct, Tunneled Direct Link Setup (TDLS), or other P2P protocol or channel between a station and a peer station may include a common network ID. In some cases of a P2P group with the common network ID, a single RPG 804 and 808 with a single color value may be used for stations sharing the common network ID.

In certain cases, a P2P group may be split into multiple RPGs. For example, RPG 804 of FIG. 8A may be split into RPG 810 and 812, as shown in FIG. 8B. A decision on splitting may be determined by a master station determined based on the P2P networking technology used. The master station may collect information from a peer P2P station on neighbor stations of the P2P peer station. For example, the master station may receive color, time slot, or frequency information from another wireless node which may or may not be a member of the P2P group. Based on this neighbor station information, the master station may determine a grouping for the multiple RPGs such that the RPGs are isolated from each other (i.e., no cross communications between member stations of each RPG).

Once RPGs are formed, the stations within an RPG may then select a color value for the RPG. This selection may be performed in a centralized or decentralized way. In an embodiment utilizing decentralized selection, individual stations of the RPG may observe and exchange information related to unused color values. Each station may listen for transmissions containing information related to color values by other neighboring stations not associated with the P2P group and determine which color values are used or which color values are not used. A color value corresponding to the unused color value observed by the most number of individual stations may then be selected. In an embodiment utilizing centralized selection, a master node may collect information related to unused color values and select a color value. This master node may also assign P2P reuse parameters, as described above, after or concurrently with RPG identification. Alternatively, these P2P reuse parameters may be predetermined based on defined standards. According to certain aspects, P2P color values may be common across all P2P groups. According to certain aspects, P2P color values may be determined based on specifications in a network communications standard.

In some cases, rather than actually transmitting a frame a device may have an interface to output a frame for transmission. For example, a processor may output a frame, via a bus interface, to a radio frequency (RF) front end for transmission. Similarly, rather than actually receiving a frame, a device may have an interface to obtain a frame received from another device. For example, a processor may obtain (or receive) a frame, via a bus interface, from an RF front end for reception. In some cases, these interfaces may be the same, for example, via a bus interface from a transceiver front end.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 in FIG. 5 may correspond to means 500A illustrated in FIG. 5A and operations 600 in FIG. 6 may correspond to means 600A illustrated in FIG. 6A.

Means for obtaining (e.g., receiving) may comprise a receiver (e.g., the receiver unit 254) and/or an antenna(s) 252 of the UT 120 illustrated in FIG. 2 or the receiver 312 and/or antenna(s) 316 depicted in FIG. 3. Means for transmitting and means for outputting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2

Means for generating, means for detecting, means for determining, means for obtaining, means for selecting, means for generating, means for processing, and/or means for assigning may include a processing system, which may include one or more processors such as processors 260, 270, 288, and 290 and/or the controller 280 of the UT 120 or the processor 304 and/or the DSP 320 portrayed in FIG. 3.

According to certain aspects, such means may be implemented by processing systems configured to perform the corresponding functions by implementing various algorithms (e.g., in hardware or by executing software instructions) described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer readable storage medium with instructions stored thereon separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be used.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a processing system configured to determine a first identifier for use in identifying an intended recipient of frames transmitted by members of a peer-to-peer group, and to generate a first frame having a signal field including the first identifier; and
a first interface configured to output the first frame for transmission to at least one of the members in the peer-to-peer group.

2. The apparatus of claim 1, further comprising:
a second interface configured to obtain a second frame; and
wherein the processing system is configured to determine the first identifier based on an identifier indicated in the second frame.

3. The apparatus of claim 1, further comprising:
a second interface configured to obtain information about identifiers used in other peer-to-peer groups; and
wherein the processing system is configured to determine the first identifier based on the information.

4. The apparatus of claim 1, further comprising:
a second interface configured to obtain a second frame from a member of the peer-to-peer group; and
wherein the processing system is configured to determine the first identifier based on an identifier indicated in the second frame.

5. The apparatus of claim 1, wherein the apparatus is a member of the peer-to-peer group.

6. The claim 1, wherein the peer-to-peer group comprises one of the following: an independent basic service set (BSS) network, a mesh BSS network, a neighborhood awareness network (NAN), and a WiFi-Direct network.

7. The apparatus of claim 1, further comprising:
a second interface configured to obtain a second frame with a signal field having a second identifier that does not match the first identifier; and
wherein the processing system is configured to determine whether or not to process one or more portions of the second frame based on one or more criteria associated with a received signal quality of the second frame.

8-9. (canceled)

10. The apparatus of claim 7, further comprising:
a second interface configured to obtain a third frame conveying at least one threshold; and
the processing system is configured to determine whether the one or more criteria are met based on the at least one threshold.

11. The apparatus of claim 1, further comprising:
a second interface configured to obtain an indication of a first time slot or a first frequency channel addressed to one or more wireless nodes; and wherein:
the processing system is further configured to:
determine at least one of a second time slot or a second frequency channel based on the indication, in which at least one of the at least one member or the one or more wireless nodes are allowed to transmit frames with the first identifier, and
generate a second frame indicating the at least one of the second time slot or the second frequency channel; and
the first interface is further configured to output the second frame for transmission to the at least one member or the at least one wireless node.

12-13. (canceled)

14. The apparatus of claim 1, further comprising:
a second interface configured to obtain an indication of a first time slot or a first frequency channel addressed to one or more wireless nodes, and wherein:
the processing system is further configured to determine at least one of a second time slot or a second frequency channel based on the indication, in which at least one of the one or more wireless nodes or the at least one member are allowed to make a decision regarding whether to process frames with different identifiers, and to generate a second frame indicating the at least one of the second time slot or the second frequency channel; and
the first interface is further configured to output the second frame for transmission to the at least one wireless node or at least one member.

15. The apparatus of claim 1, wherein the first identifier comprises a common peer-to-peer identifier for peer-to-peer groups and wherein the common peer-to-peer identifier is specified in a network communications standard.

16. An apparatus for wireless communications, comprising:
a processing system configured to assign a first identifier to a first peer-to-peer group for use in identifying intended recipients of frames transmitted by members of the first peer-to-peer group, and to generate a first frame having an indication of the first identifier; and
a first interface configured to output the first frame for transmission to at least one of the members of the first peer-to-peer group.

17. The apparatus of claim 16, wherein the first identifier comprises an identifier assigned to a basic service set (BSS) associated with the apparatus.

18. The apparatus of claim 16, wherein the first identifier is different from an identifier assigned to a basic service set (BSS) associated with the apparatus.

19. The apparatus of claim 16, wherein the members of the first peer-to-peer group are associated with at least one basic service set (BSS) and the first identifier comprises an identifier common for all peer-to-peer wireless nodes associated with the at least one BSS.

20. The apparatus of claim 16, wherein the processing system is further configured to assign a second identifier, different than the first identifier, to a second peer-to-peer group for use in identifying intended recipients of frames transmitted by members of the second peer-to-peer group.

21. (canceled)

22. The apparatus of claim 16, wherein the processing system is further configured to assign a second identifier to a second peer-to-peer group for use in a time slot different from a time slot used by the first peer-to-peer group.

23. The apparatus of claim 16, wherein:
the processing system is configured to generate a second frame with information about identifiers, including the first identifier, assigned to one or more peer-to-peer groups including the first peer-to-peer group; and
the first interface is further configured to output the second frame for transmission.

24. (canceled)

25. The apparatus of claim 16, further comprising:
the processing system is configured to generate a second frame with information regarding one or more criteria for the members of the first peer-to-peer group to use for determining whether or not to process one or more portions of a frame with a signal field having a second identifier that does not match the first identifier; and
the first interface is further configured to output the second frame for transmission.

26-86. (canceled)

87. A wireless node, comprising:
a processing system configured to determine a first identifier for use in identifying an intended recipient of frames transmitted by members of a peer-to-peer group, and to generate a first frame having a signal field including the first identifier; and
a transmitter configured to transmit, via the antenna, the first frame to at least one of the members in the peer-to-peer group.

88. (canceled)
